(19) United States
(12) Patent Application Publication
(10) Pub. No.: US 2021/0086357 A1
(43) Pub. Date: Mar. 25, 2021

(54) Device and Method for Robotic Tool Adjustment

(71) Applicant: Jim Peyton, Richmond, KY (US)

(72) Inventor: Jim Peyton, Richmond, KY (US)

(21) Appl. No.: 17/029,694

(22) Filed: Sep. 23, 2020

Related U.S. Application Data
(60) Provisional application No. 62/905,813, filed on Sep. 25, 2019.

(51) Int. Cl. B25J 9/16; B25J 15/00

(52) U.S. Cl. CPC B25J 9/1664; B25J 15/0052

(57) ABSTRACT

An automated material handling system includes a handling tool that can be automatically adjusted to accommodate a variety of work piece sizes and shapes. The handling tool can be a robotic arm that can be configured with rotary joints, linear joints, or both and uses brakes and sensors on each joint to adjust and monitor the shape of the handling tool.

### CROSS REFERENCE TO RELATED APPLICATIONS

This application claims priority to U.S. Application Ser. No. 62/905,813, filed on Sep. 25, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present disclosure relates to an automated material handling system with an adjustable handling tool.

### Description of the Related Art

An automated material handling system may be required to process a variety of component shapes and sizes. In the case of a material handling system using a robot with a handling tool to pick up work pieces in one location and transfer them to another location, this work piece variation requires altering the shape and size of the handling tool used to grip the work piece.

A first present method of altering the handling tool is to completely change the tool being used by the robot. This is done by detaching the tool in use and attaching a different tool. This method provides the needed variation but requires many different tools to be built and a large amount of space devoted to the storage of these tools. In the case of automated detachment and attachment of the tools, laborious path programming is required of the robot to accomplish the tool change.

A second present method of altering the tool is to include on the tool actuators, such as motors or air cylinders, and moveable gripping elements. The actuators move the gripping elements to alter the shape of the tool. This approach provides adjustability while avoiding the storage space problem of detachable tools, however, it results in a complex and heavy mechanism. The size and weight of the mechanism can force the use of larger and more costly robots than would otherwise be required. The complexity of the mechanism makes it expensive to build and expensive to maintain.

A third present method of altering the tool is to use moveable gripping elements held in place with braking mechanisms. Adjustment in this method is done through the following process: The robot carries the tool to an adjustment location where there is fix-mounted device that contains a clamping mechanism that can be actuated by the robot; The clamp is actuated so that it grips one of the moveable elements, holding it in position; The brake on that moveable element is released; The robot repositions the tool while the one moveable element is held in position, thus changing the moveable element's position relative to the rest of the tool; The brake is reengaged on the moveable element; The clamp is actuated in reverse, releasing the moveable element; The process is repeated as needed for other moveable elements on the tool.

This third method provides the tool with adjustability as in the second method, but with a significant reduction in weight and cost of the tool. However, this method has a significant drawback. In this method, the robot controller no longer has feedback of the actual position of the moveable elements during operation. Automated work piece handling systems will occasionally have collisions between the tool and a fixed object. The severity of the collisions can be strong enough to overcome the holding force of the braking elements and cause the moveable elements to change position. Even absent a collision, other abnormal conditions can cause the moveable elements to change positions unexpectedly. The lack of positional feedback on the moveable elements prevents the robot controller from validating the tool configuration during operation and could lead to mishandling of work pieces during operation.

The lack of positional feedback also creates problems in the adjustment process itself. The adjustment process envisioned by this third method requires the position of the moveable element to be known before the start of the adjustment sequence. The moveable element cannot be reliably brought to the adjustment location without knowledge of the position of the moveable element. A mispositioned moveable element will not be captured by the clamp and the robot will not be able to adjust the tool. Without positional feedback, the adjustment method will be unreliable, requiring human intervention on a regular basis.

### SUMMARY OF THE INVENTION

A device and method for handling tool adjustment is disclosed herein that includes a multi-axis robot, a handling tool, a controller and an adjustment station. The device and method have the desirable ability to: Provide adjustability of the handling tool by using moveable elements so as to avoid the storage space required by present methods that use detachable handling tools; Provide adjustability of the handling tool while eliminating the heavy, complex and expensive actuators needed in some present methods for adjusting the moveable elements; Provide adjustability of the handling tool using moveable elements that can be locked and unlocked with a braking element and that contain position monitoring elements that provide feedback to the robot to allow validation of the tool configuration at any time.

In one embodiment, the handling tool is mounted to a 6-axis robot with a controller to create an automated material handling system with the ability to pick, transfer and place a variety of work pieces. The system has the ability to adjust the shape of the handling tool by changing the position of moveable elements on the handling tool by interacting with the adjustment station.

### BRIEF DESCRIPTION OF THE DRAWINGS

FIG. 1A is a conceptual explanatory view of an example automated handling system with adjustment station.

FIG. 1B is a second conceptual explanatory view of an example automated handling system with adjustment station.

FIG. 1C is a third conceptual explanatory view of an example automated handling system with adjustment station.

FIG. 2 is a schematic drawing of the controller.

FIG. 3 is a more detailed conceptual explanatory view of an example moveable element of the handling tool.

FIG. 4A is a diagram showing an example joint of a moveable element with brake and position feedback.

FIG. 4B is a section view of an example joint of a moveable element with brake and position feedback.

FIG. 5 is a flow chart showing an example method of handling system operation.

FIG. 6 is a detailed conceptual explanatory view of an example adjustment station.

FIG. 7 is a conceptual explanatory view of an example automated handling system using an adjustment station

FIG. 8 is a flow chart showing an example method of handling tool adjustment

### DETAILED DESCRIPTION

The various features, advantages, and other uses of the present device and method will become more apparent by referring to the following detailed descriptions and drawings. The drawings are not necessarily to scale, emphasis instead placed upon illustrating the principals of the invention.

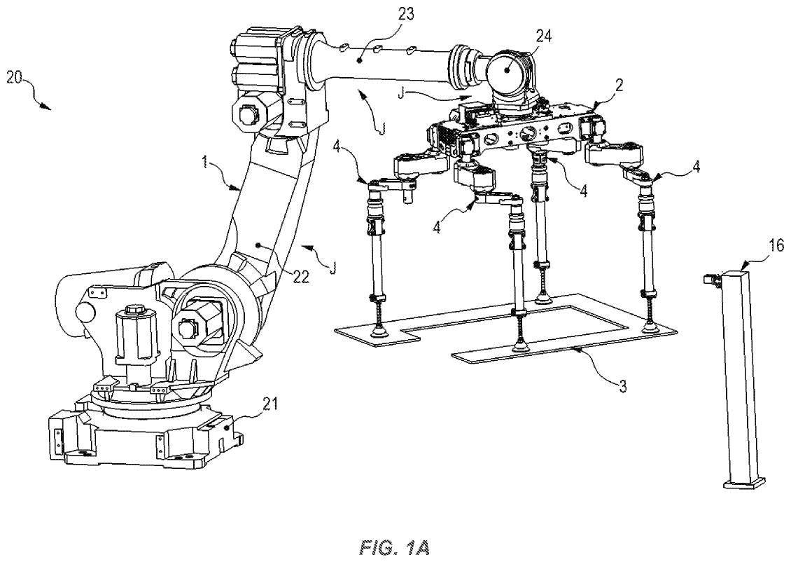

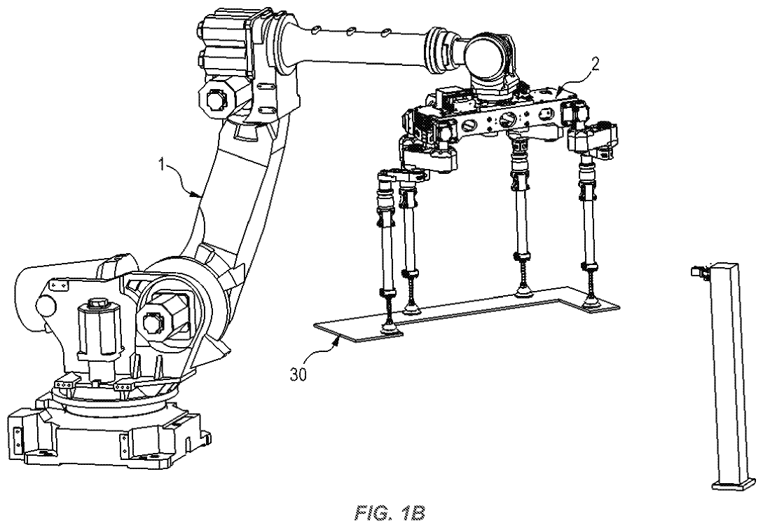

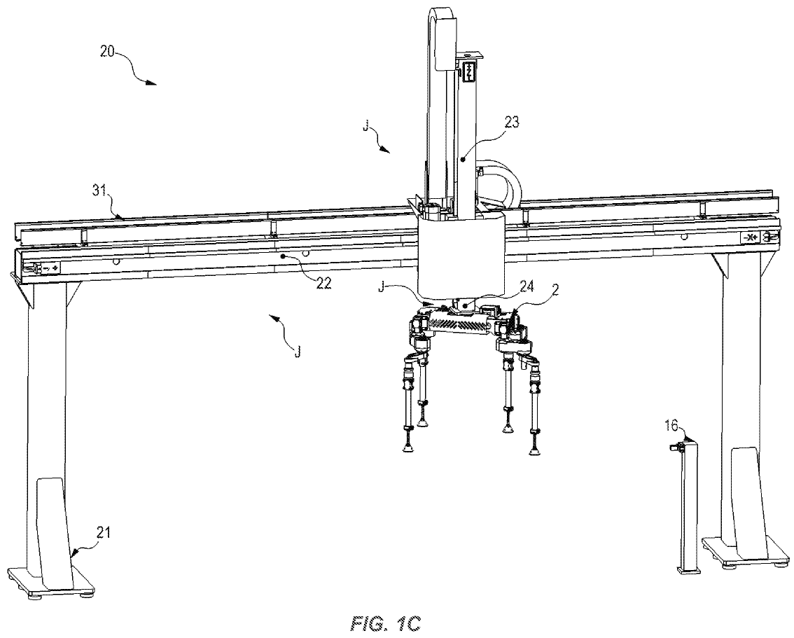

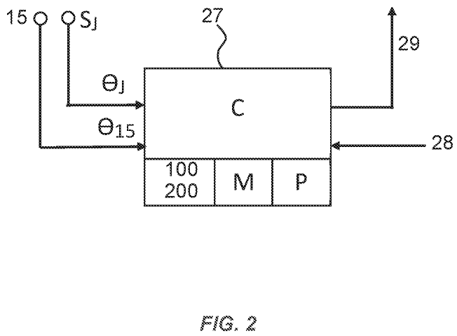

The preferred embodiment of the present invention is shown in FIG. 1A. An automated material handling system 20 comprised of a multi-axis robot 1, a controller (C) 27, a handling tool 2 that is capable of picking, carrying and placing a work piece 3 using multiple gripping arms 4, and an adjustment station 16. The robot 1 may be embodied as a conventional 6-axis industrial robot as shown, and therefore may include a fixed or mobile base 21 and a plurality of robotic joints J, at least some of which are shown in FIG. 1A. The various joints J connect segments or serial linkages of the robot 20, including a lower arm 22, an upper arm 23, and a wrist 24, and collectively provide the desired range of motion and number of control degrees of freedom needed for performing assigned work tasks.

Joint position sensors S_{J} are positioned with respect to each robot joint RJ and configured to measure and report the joint positions (arrow θ_{J}) to the controller 27. Overall control of the automated material handling system 20 is provided by the controller 27. The controller 27 may be configured as a host machine, e.g., a digital computer, that is specially programed to execute steps of the embodied methods. To that end, the controller 27 includes sufficient hardware to perform the required method steps, i.e., with sufficient memory (M), a processor (P), and other associated hardware such as a high-speed clock, analog-to-digital and/or digital-to-analog circuitry, a timer, input/output circuitry and associated devices, signal conditioning and/or signal buffering circuitry. The memory (M) includes sufficient tangible, non-transitory memory such as magnetic or optical read-only memory, flash memory, etc., as well as random access memory, electrically erasable programmable read only memory, and the like.

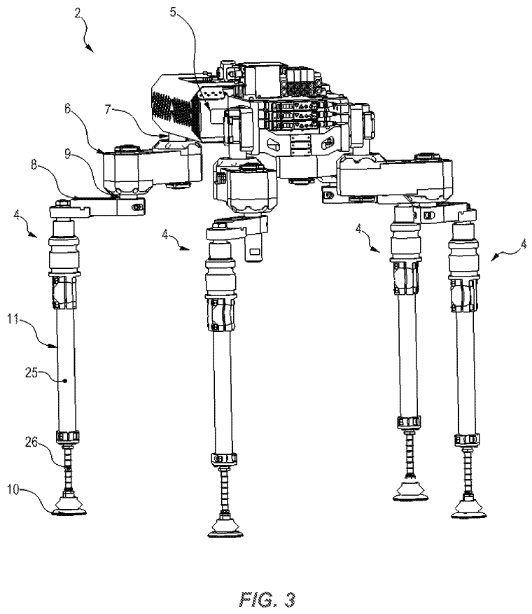

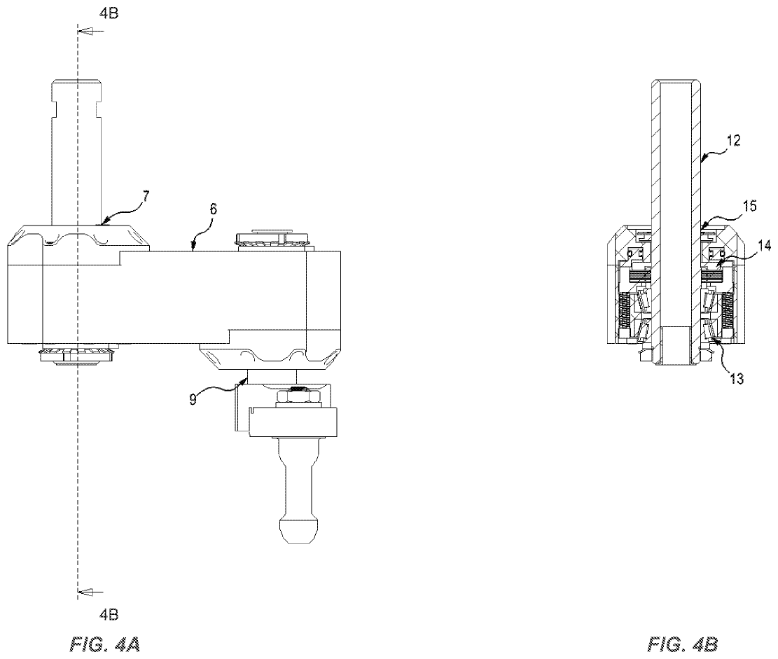

The handling tool 2 as in FIG. 3 is comprised of a frame 5 to which the multiple gripping arms 4 are mounted. The gripping arms 4 are comprised of a first link 6 that connects to the frame through a rotary joint 7, a second link 8 that connects to the first link through a rotary joint 9, and a gripping element 10 such as a suction cup, magnet or mechanical gripper 10 attached to the second link 8 using a standoff 11. These standoffs are well known in the art and are typically a combination of a rigid tube 25 and a spring compliance device 26

The first link 6 is as in FIG. 3 and contains both rotary joint 7 and rotary joint 9. Each rotary joint is comprised of a shaft 12, bearing 13, brake 14, and a position sensor 15. The shaft, bearing and brake are typical items well known in the art. An example of a position sensor 15 well known to the art is an encoder. The term “encoder” refers to a device that attaches to a moving element of a mechanism and provides the position of that element. Such devices are available for rotary and linear motion elements and can provide incremental position information or absolute position information relative to an established zero position.

As part of the executing the embodied methods, the controller 27 receives the measured robot joint positions (arrow θ_{J}) from the position sensors (S_{J}) and measured gripper arm positions (arrow θ₁₅) from the position sensors 15 while operating. The controller 27 generates or receives input signals (arrow 28) informing the controller 27 as to the required work tasks to perform and outputs control signals (arrow 29) to the robot 1, handling tool 2 and adjustment station 16 to command the required actions from those devices.

The automated material handling system 20 has two principal modes of operation: method 100 and method 200. Method 100 describes the repetitive mode of transferring work pieces while monitoring the condition of handling tool 2. Method 200 describes the handling tool 2 adjustment method.

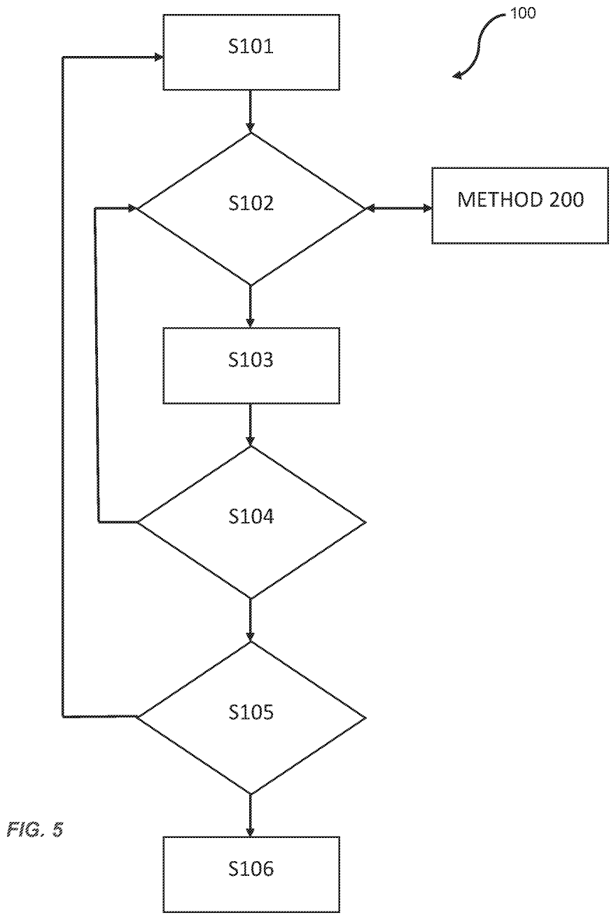

Referring to FIG. 5, an example embodiment of method 100 starts with S101. In this step, the controller 27 selects a work task to be performed by the robot 1. For instance, the controller 27 may be informed via the input signals (arrow 50) that the robot 1 is required to grip and move the work piece 30 shown in FIG. 1B. The controller 27 may thereafter extract from its memory (M) the required handling tool configuration for executing the required work task. The saved handling tool configuration is defined by the required positions (arrow θ₁₅) of all the gripper arms on the handling tool. Method 100 proceeds to step S102 once the controller 27 is aware of the task to be performed and the configuration is loaded in memory (M).

At S102, the controller 27 compares the current gripper arm positions (arrow θ₁₅) to the positions required by the stored configuration. If all positions match, controller 27 makes a “yes” determination and method 100 proceeds to S103. If the positions do not match, the controller makes a “no” determination and method 200 is used to adjust the handling tool 2. (Method 200 will be discussed separately below.)

At S103, the controller 57 guides the robot to perform the required work, such as picking up a piece of sheet metal and placing it in a press, with the handling tool 2 that has been confirmed to match the work piece. Method 100 proceeds to S104

At S104, the controller determines whether all operations on similar work pieces are complete. For instance, if a batch of a predetermined number of work pieces is to be lifted and deposited on an assembly line, the controller 27 will determine at step S104 whether work on all of the predetermined number of work pieces has been completed. The method 100 proceeds to step S105 when the batch is complete. If the batch is not complete, method 100 returns to step S102. This is where a significant advantage of the current invention is realized. Prior art would have the sequence return to step S103 and continuing processing work pieces assuming that the handling tool 2 was still in the correct configuration because, without position sensors 15 on the gripper arms, there is no way to verify the arm positions (arrow θ₁₅) match the stored configuration. With the method 100 described here, the handling tool 2 configuration is validated on every work cycle. Without this validation, an erroneous handling tool configuration can exist, resulting in missed picks or collisions between the handling tool and some other fixed object.

At S105, the controller 27 determines if another work task is to be performed by robot 1. If a new work piece configuration is to be processed, method 100 returns to step S101. If no work tasks are required, method 100 moves to S106.

At S106, the handling system 20 is in a standby state in which controller 27 waits for additional input instructions.

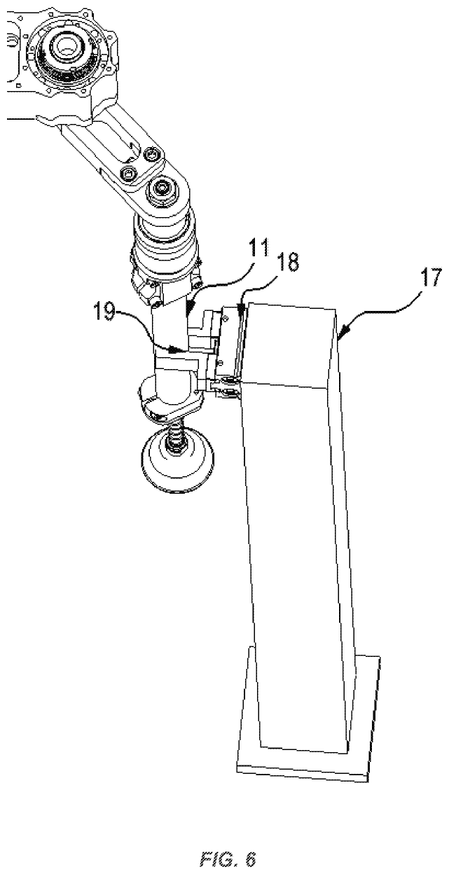

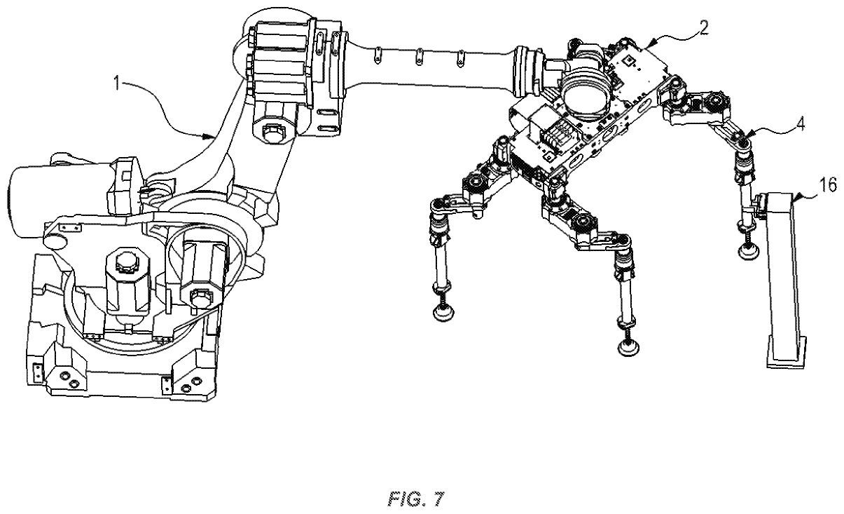

The adjustment station 16 is as in FIG. 6 comprised of a fixed post 17 to which is mounted an actuator 18 with gripping details 19 that are capable of grasping standoff 11. FIG. 6 depicts the manner in which robot 1 uses the adjustment station during method 200.

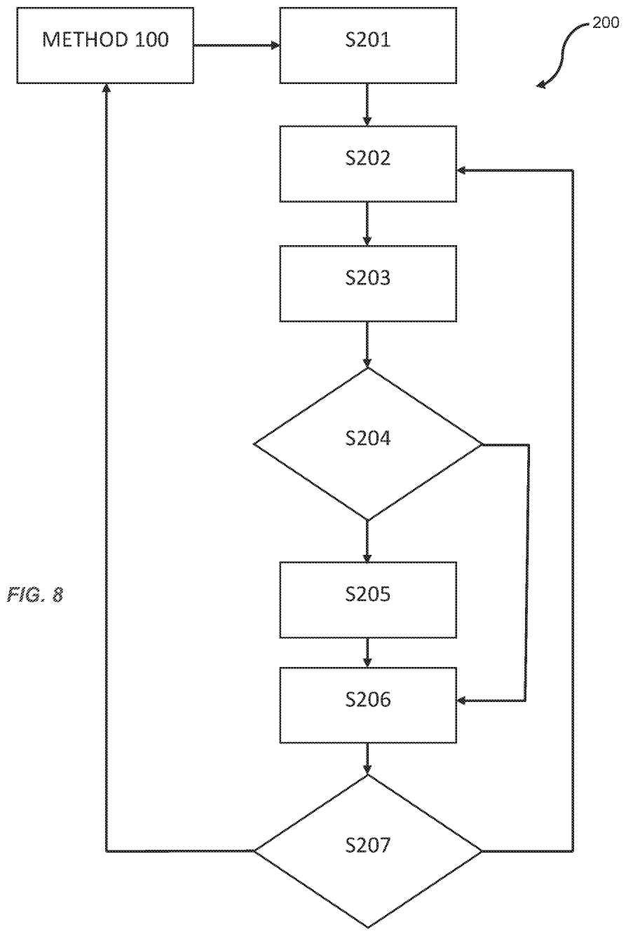

Referring to FIG. 8, an example embodiment of method 200 starts with S201. The handling system 20 has arrived at this step because the handling 2 configuration does not match the configuration required to perform the task. In this step, the controller 27 determines which gripper arm positions (arrow θ₁₅) must change to make the handling tool 2 configuration match the configuration loaded into memory at S101. Once the required adjustments are determined, method 200 moves to S202.

At S202, the controller 27 directs the robot to position the standoff 11 of one of the gripping arms 4 of handling tool 2 between the gripping details 19 of the adjustment station 16. The controller 27 then directs the actuator 18 to close, fixing that standoff 11 in position. Once the standoff is so fixed, method 200 moves to S203.

At S203, with the standoff 11 now fixed in location, controller 27 releases brake 14 in rotary joint 7 and directs robot 1 to reposition handling tool 2 in a manner that causes rotation of rotary joint 7 to the desired position. Once controller 27 confirms position (arrow θ₁₅) by position sensor 15, brake 14 is reengaged to hold joint 7 in position. With joint 7 in position, method 200 moves to S204.

At S204, controller 27 determines whether joint 9 needs to be adjusted to match the required configuration. If no adjustment is required, method 200 moves to S206. If adjustment is needed, method 200 moves to 205.

At S205, the brake 14 in rotary joint 9 is now released and robot 1 repositions handling tool 2 in a manner that causes rotation of rotary joint 9 to the desired position. Once controller 27 confirms position (arrow θ₁₅) by position sensor 15, brake 14 is reengaged to hold joint 9 in position. With joint 9 in position, method 200 moves to S206

At S206, both joints of one gripper arm 4 are now in position. Controller 27 releases actuator 18 to spread the gripping details 19 and release standoff 11. Controller 27 directs the robot to retract from the adjustment station. Method 200 moves to S207.

At S207, the controller 27 determines whether all gripper arms 4 have been adjusted. If not, method 200 returns to step 202, presenting the next gripper arm 4 to be adjusted. If the configuration of handling tool 2 matches the required configuration, method 200 returns to method 100 at S102 so that work can proceed.

There are alternate embodiments of each of the devices that comprise the present invention. An alternate embodiment of the present invention can be formed using one or a combination of many of the following alternate device embodiments. In one alternate embodiment, an articulated arm robot of more or fewer axis of motion is used as the motion system for the handling tool. In another alternate embodiment, a cartesian style robot 31 as shown in FIG. 1C is used as the motion system for the handling tool. This multi-axis robot, as in robot 1, has a fixed or mobile base 21, contains joints (J), carries the handling tool 2, is directed by a controller 27 and interacts with the adjustment station 16. In another alternate embodiment, more or fewer gripping arms are used to comprise the handling tool. In another alternate embodiment, the gripping arms have more or fewer number of rotary joints. In another alternate embodiment, linear joints are used instead of rotary joints to allow adjustment of the gripping arms. In another alternate embodiment, not every joint contains a brake. In another alternate embodiment, not every joint contains a position sensor. In another alternate embodiment, the method of capturing the standoff for tool adjustment is changed a passive capturing device such as a hook, pin, or magnet. In another alternate embodiment, the method of capturing the standoff for tool adjustment is changed to so that the gripping element on the end of the standoff is used to grip a fixed element of the adjustment station. In another alternate embodiment, the gripping elements may attach directly to the gripper arm without the use of a standoff. In other alternate embodiments, the order of the adjustment of the joints is altered.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures. While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

I claim:

1. An automated material handling system comprising:
a multi-axis robot having an arm & a wrist;
a handling tool containing a frame and multiple adjustable gripper arms, where each arm is configured from one or more serial links connected by rotary joints where each joint contains a brake and a position sensor, and where each gripping arm contains a gripping element that mounts to a link directly or mounts using a standoff;
an adjustment station that, when engaged with the end of a gripper arm containing the gripping element, can fix this end in space;
a controller programmed to command the robot to automatically adjust the handling tool by presenting each gripper arm to the adjustment station so that it may be fixed in space, by unlocking one or more joints on that arm, by moving the handling tool to cause movement in those unlocked joints, by using position sensors to confirm that those unlocked joints achieve the correct position during adjustment, by locking the joints once they are in the correct position, and by repeating the adjustment process until all joints on all arms are correctly adjusted.

2. The automated handling system of claim 1, wherein the controller is programmed to command the robot to use the handling tool to perform work and during that work periodically confirms the position of the gripper arms using the position sensors on those arms.

3. The automated handling system of claim 2, wherein some gripper arm joints do not have brakes, do not have position sensors, or have neither brakes nor position sensors.

4. An automated material handling system comprising:
a multi-axis robot having an arm & a wrist;
a handling tool containing a frame and multiple adjustable gripper arms, where each arm is configured from one or more orthogonal links connected by linear joints where each joint contains a brake and a position sensor, and where each gripping arm contains a gripping element that mounts to a link directly or mounts using a standoff;
an adjustment station that, when engaged with the end of a gripper arm containing the gripping element, can fix this end in space;
a controller programmed to command the robot to automatically adjust the handling tool by presenting each gripper arm to the adjustment station so that it may be fixed in space, by unlocking one or more joints on that arm, by moving the handling tool to cause movement in those unlocked joints, by using position sensors to confirm that those unlocked joints achieve the correct position during adjustment, by locking the joints once they are in the correct position, and by repeating the adjustment process until all joints on all arms are correctly adjusted.

5. The automated handling system of claim 4, wherein the controller is programmed to command the robot to use the handling tool to perform work and during that work periodically confirms the position of the gripper arms using the position sensors on those arms.

6. The automated handling system of claim 5, wherein some gripper arm joints do not have brakes, do not have position sensors, or have neither brakes nor position sensors.

7. An automated material handling system comprising:
a multi-axis robot having an arm & a wrist;
a handling tool containing a frame and multiple adjustable gripper arms, where each arm may be configured from one or more orthogonal links connected by linear joints and one or more serial links connected by rotary joints, where each joint contains a brake and a position sensor, and where each gripping arm contains a gripping element that mounts to a link directly or mounts using a standoff;
an adjustment station that, when engaged with the end of a gripper arm containing the gripping element, can fix this end in space;
a controller programmed to command the robot to automatically adjust the handling tool by presenting each gripper arm to the adjustment station so that it may be fixed in space, by unlocking one or more joints on that arm, by moving the handling tool to cause movement in those unlocked joints, by using position sensors to confirm that those unlocked joints achieve the correct position during adjustment, by locking the joints once they are in the correct position, and by repeating the adjustment process until all joints on all arms are correctly adjusted.

8. The automated handling system of claim 7, wherein the controller is programmed to command the robot to use the handling tool to perform work and during that work periodically confirms the position of the gripper arms using the position sensors on those arms.

9. The automated handling system of claim 8, wherein some gripper arm joints do not have brakes, do not have position sensors, or have neither brakes nor position sensors.
